(19) United States
(12) Patent Application Publication
(10) Pub. No.: US 2023/0078297 A1
(43) Pub. Date: Mar. 16, 2023

(54) Pacifier Face Shield

(71) Applicant: Stephen Wall, Sicklerville, NJ (US)

(72) Inventor: Stephen Wall, Sicklerville, NJ (US)

(21) Appl. No.: 17/475,188

(22) Filed: Sep. 14, 2021

(51) Int. Cl. A61J 17/00; A41D 13/11

(52) U.S. Cl. CPC A61J 17/10; A61J 17/001; A41D 13/11

(57) ABSTRACT

The pacifier face shield provides comfort to the child through the pacifier, while preventing the spread of airborne communicable diseases to children under two. The pacifier face shield introduces an opening in the shield where parents can conveniently screw on their child's pacifier. The child will be able to use the pacifier as they normally would, while the face shield covers the child mouth, nose and eyes to ensure the infant is both protected against any pathogens, diseases and bacteria, and comfortable while wearing the pacifier face shield.

### BACKGROUND

A pacifier is a rubber, plastic, or silicone nipple substitute given to an infant to suckle upon between feedings to quiet its distress by satisfying the need to suck when it does not need to eat. Pacifiers normally have three parts, an elongated teat, a mouth shield, and a handle. The mouth shield is large enough to prevent the child from attempting to take the pacifier into its mouth, and so forecloses the danger that the child will swallow then choke on it. A face shield, an item of personal protective equipment (PPE), aims to protect the wearer's entire face (or part of it) from hazards such as flying objects and road debris, chemical splashes (in laboratories or in industry), or potentially infectious materials (in medical and laboratory environments).

### SUMMARY OF THE INVENTION

The main purpose of pacifier face shield is to provide young children with a multi-functional face shield with a built in pacifier. Given the severity of the current Covid-19 situation, it is essential that children are adequately protected against this harmful and highly transmissible disease to avoid any unwanted outcomes. Unfortunately however, there is nothing in the market that will help infants and young children defend themselves against the Covid-19 virus, thus increasing their likelihood of virus contraction. Not only does this place the infant in a position of risk, but it has also created a problematic situation for parents as they are unable to take their children to public places or foreign environments without panicking about their child's health and safety.

The pacifier face shield provides comfort to the child through the pacifier, while preventing the spread of airborne communicable diseases to children under two. Expanding on the initial design of an average face shield, the pacifier face shield introduces a novel opening in the shield where parents can conveniently screw on their child's pacifier. The child will be able to use the pacifier as they normally would, while the face shield covers the child mouth, nose and eyes to ensure the infant is both protected against any pathogens, diseases and bacteria, and comfortable while wearing the pacifier face shield.

### BRIEF DESCRIPTION OF THE DRAWINGS

FIG. 1 is a frontal view of the pacifier face shield with a pacifier connected to it in accordance with an embodiment of the present disclosure.

FIG. 2 is a top view of the pacifier face shield with the face shield and pacifier unconnected from each other in accordance with an embodiment of the present disclosure.

FIG. 3 is a top view of the pacifier face shield connected to a pacifier in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

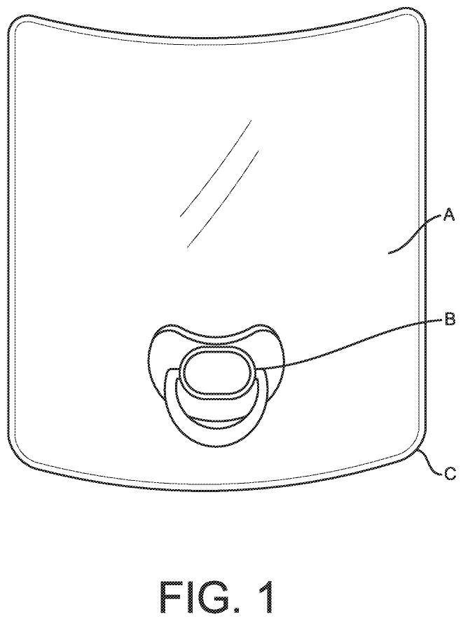

FIG. 1 is a frontal view of the pacifier face shield with a pacifier connected to it in accordance with an embodiment of the present disclosure.

Reference A depicts the plastic face shield. Reference B depicts the pacifier penetrating the shield. Reference C depicts the bumper edge of the plastic shield, which is smooth to prevent cuts. Reference D depicts the female end of the pacifier. Reference E depicts the opening in the face shield. Reference F depicts the male screw-in pacifier handle, which goes on the other side of the face shield.

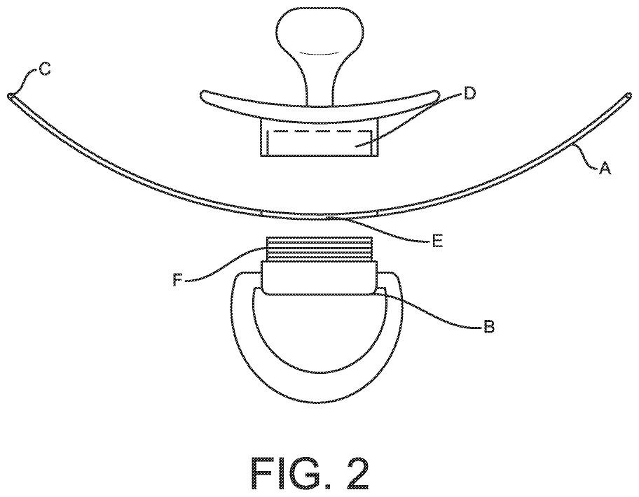

FIG. 2 is a top view of the pacifier face shield with the face shield and pacifier unconnected from each other in accordance with an embodiment of the present disclosure.

Reference A depicts the plastic face shield. Reference B depicts the pacifier penetrating the shield. Reference C depicts the bumper edge of the plastic shield, which is smooth to prevent cuts. Reference D depicts the female end of the pacifier. Reference E depicts the opening in the face shield. Reference F depicts the male screw-in pacifier handle, which goes on the other side of the face shield.

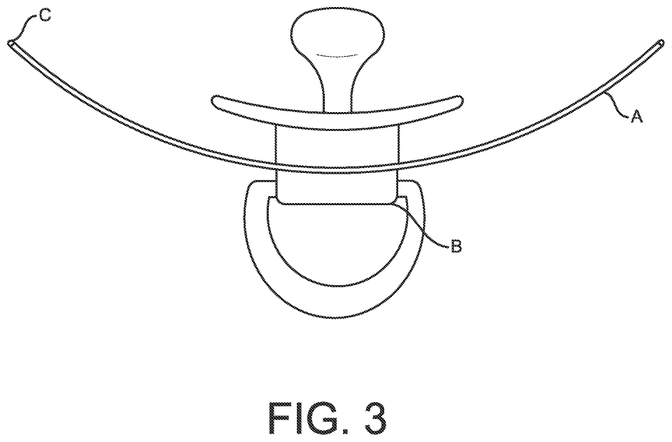

FIG. 3 is a top view of the pacifier face shield connected to a pacifier in accordance with an embodiment of the present disclosure.

Reference A depicts the plastic face shield. Reference B depicts the pacifier penetrating the shield. Reference C depicts the bumper edge of the plastic shield, which is smooth to prevent cuts.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A personal shield comprising:
a pacifier having a female end and a male end configured to mate and produce a pacifier with a nipple and a handle; and
a shield configured to define an opening for the pacifier wherein the opening is smaller in a perimeter than a perimeter of the pacifier.

2. The personal shield of claim 1, wherein the female end comprises the nipple.

3. The personal shield of claim 1, wherein the male end comprises the handle.

4. The personal shield of claim 1, wherein the shield curves back from the pacifier in the shield on both a left end and a right end.

5. The personal shield of claim 1, wherein the shield comprises rounded bumper edges on both a left side and a right side.

6. The personal shield of claim 1, wherein the female end and the male end mate together via respective complementary threaded ends.

7. The personal shield of claim 1, wherein the shield is translucent.

8. The personal shield of claim 1, wherein the handle is hinged on the male end opposite a respective threads thereof.

9. The personal shield of claim 1, wherein a pacifier shield connected to the female end matches a curvature of the shield.

10. The personal shield of claim 1, wherein a perimeter of the pacifier is circular.

11. The personal shield of claim 1, wherein a perimeter of the male end and a perimeter of the female end is oval.

12. A pacifier comprising:
a shield large enough to shield a face of a child user and configured to define a pacifier attached thereto so that a handle is one side of the shield and a nipple is on another side of the shield,
wherein the pacifier is located in a middle of bottom half of a length of the shield and in a center of a width thereof.

13. The personal shield of claim 12, wherein the shield curves back from the pacifier in the shield on both a left end and a right end.

14. The personal shield of claim 12, wherein the shield comprises rounded bumper edges on both a left side and a right side.

15. The personal shield of claim 1, wherein the shield is translucent.

16. The personal shield of claim 1, wherein a perimeter of the pacifier is circular.
